(19) United States
(12) Patent Application Publication
(10) Pub. No.: US 2021/0259225 A1
(43) Pub. Date: Aug. 26, 2021

(54) QUICK RELEASE MECHANISM AND SYSTEM FOR FISHING GEAR

(71) Applicant: Noah Saunders, D'Iberville, MS (US)

(72) Inventor: Noah Saunders, D'Iberville, MS (US)

(21) Appl. No.: 17/166,796

(22) Filed: Feb. 3, 2021

Related U.S. Application Data
(60) Provisional application No. 62/969,221, filed on Feb. 3, 2020.

(51) Int. Cl. A01K 85/18; A01K 91/04

(52) U.S. Cl. CPC A01K 85/18; A01K 91/04

(57) ABSTRACT

The invention provides a quick-attach system including a base locking mechanism and a mated lure connector mechanism, such as a plug and socket arrangement. For example, a socket (“female member”) component, adapted to be fixed to a fishing line and a set of one or more mated plug (“male member”) component that is integrated or attached to a lure or other piece of fishing gear. Likewise, the lure may include the socket/female member and the base attached to the fishing line may include the plug/male member.

### CROSS-REFERENCE TO RELATED APPLICATIONS

The present invention claims the benefit of priority to U.S. Prov. Pat. App. No. 62/969,221 filed Feb. 3, 2020 (113137.001PRV), entitled IMPROVED QUICK RELEASE MECHANISM AND SYSTEM FOR FISHING GEAR (Saunders), which is incorporated by reference herein in its entirety.

### FIELD OF THE INVENTION

Fishing gear or tackle and in particular connection mechanisms for connecting lures and other fishing gear to fishing line.

### BACKGROUND OF THE INVENTION

Fishing is a broad category of activity. For some fishing is a recreational source of leisure and for others fishing or “sportfishing” is a sport and may involve competition. Professional fishers compete in numerous competitions targeting various species throughout the US and abroad. These pursuits often require specialized tackle and equipment. Selection of fishing gear, also referred to as tackle and equipment, often depends on the species of fish targeted and should match the fishing conditions to promote success.

In its purest form, tackle includes a rod and a reel spooled with fishing line which terminates in one or more or various combinations of hooks, lures and/or bait. Traditionally terminal tackle has been attached to the fishing line by means of tying a knot. In order to replace the lure, or the rig in its entirety, the fisher must cut or untie the knot to disconnect a first lure and then tie the fishing line to a second lure. This can take a considerable amount of time. Such involved action does not permit a fisher to act quickly when changing lures. This can result in lost opportunities. Although other attachment mechanisms exist, they are often not consistent from lure to lure and may not be adaptable for use much less quick replacement by a fisher.

One key need in fishing is the need to attach a lure, which typically includes one or more hooks for snagging fish when the fish bites or swallows the lure “bait.” One need for fishing enthusiasts of all types is to quickly secure, replace, or switch from a variety of lures or other terminal tackle, as a result of changing the targeted fish species or the conditions encountered in the body of water being fished. A common problem with prior art connecting mechanisms is effort required to add or change tackle as they lack an effective way to quickly attach/detach lures or other terminal tackle to the fishing line.

What is needed is a mechanism that enables fishing enthusiasts to quickly and securely attach/detach lures while fishing. Another need is a system of lures or other terminal tackle with common attachment means to enable a fisher to quickly change his/her presentation by switching among a set of lures/tackle to improve the fishing experience.

### SUMMARY OF THE INVENTION

Various aspects of the invention address one or more of the above-discussed problems or drawbacks associated with known lure attachment mechanisms.

One aspect of the invention is to provide quick-attach or “quick-acting” couplings that provide fishers with a fast, convenient and easy to operate means for repeatedly connecting and disconnecting lures and other terminal tackle to fishing lines.

“A quick connector of the ball-lock type includes a socket member, a plug member and a slidable sleeve which are specifically designed to permit manufacture by deep drawing of a sheet metal. The socket member and the plug member are each shaped in the form of a stepped tube and the plug member is inserted into the socket member in a telescoping fashion to form an annular chamber therebetween. An 0-ring and a backup ring are mounted within the annular chamber by inserting them into the bore of the socket member.”

Quick-acting (or quick connect/disconnect) couplings essentially all have three common elements: a plug, a socket, and a locking mechanism. The plug is the “male” half and the socket is the “female” half. When connected, the parts connected by way of the plug and socket form a joint or junction and are locked and resist tensile forces that tend to pull the joint apart. Typically, the parts may be easily disconnected by hand by simply disengaging a locking mechanism and separating the parts respectively connected to the plug and socket. For example, the invention may be in the form of a ball-lock coupling (for example having a ring-shaped ball bearing component retained in a sleeve component capable of being slidingly engaged and disengaged to permit placement and removal), a roller-lock coupling (rollers are positioned around the inner diameter of the socket to grip the plug), a pin-lock coupling (uses pins arranged in a truncated-cone formation to grip and hold the plug in the socket), or a cam and groove or “camlock” style quick connect/disconnect.

One prior art quick-attach mechanism was disclosed in U.S. Pat. No. 6,206,432 (Kamiyama), the entirety of which is hereby incorporated herein by reference, as “A quick connector of the ball-lock type includes a socket member, a plug member and a slidable sleeve which are specifically designed to permit manufacture by deep drawing of a sheet metal. The socket member and the plug member are each shaped in the form of a stepped tube and the plug member is inserted into the socket member in a telescoping fashion to form an annular chamber therebetween. An O-ring and a backup ring are mounted within the annular chamber by inserting them into the bore of the socket member.”

Another prior art quick-attach mechanism was disclosed in U.S. Pat. No. 4,485,845 (Brady), the entirety of which is hereby incorporated herein by reference, as “A female quick disconnect coupling includes a locking mechanism which requires different forces to connect and disconnect a male coupling. A tubular housing is slidably mounted within a sleeve, and a pair of coil springs are mounted between the housing and the sleeve. Only one of the springs is compressed as the housing moves in one direction within the sleeve to permit a male coupling to be connected to the female coupling. Both springs are compressed as the housing moves in the other direction to permit the male coupling to be disconnected, thereby requiring a relatively high force to disconnect the couplings.”

Quick-attach couplings are often used in fluid systems to make and break fluid connections to allow or disallow flow of fluid between a source of fluid to a destination receiver. Quick-attach couplings are often used to easily connect in a secure manner a first object with a second object as part of a system.

The invention provides a quick-attach system including a base locking mechanism and a mated lure connector mechanism, such as a plug and socket arrangement. For example, a socket (“female member”) component, adapted to be fixed to a fishing line and a set of one or more mated plug (“male member”) component that is integrated or attached to a lure or other piece of fishing gear. Likewise, the lure may include the socket/female member and the base attached to the fishing line may include the plug/male member.

In a first exemplary embodiment, the invention provides a fishing lure or terminal tackle comprising: a body having a first end and a second end; a hook fixably secured to the body at the first end; a quick-attach socket component affixed to the body at the second end and having a female receiving portion adapted to removably receive and attach a male plug component; and a separable quick-attach plug component configured to be mating received into the socket and having a fishing line connector for attaching a fishing line to the lure; and a locking component whereby the plug component may be inserted into the socket component in a secure fashion for use in fishing and may be quickly removed from the socket for switching lures without removing or disturbing the fishing line attached to the plug component; a ball-lock coupling (for example having a ring-shaped ball bearing component retained in a sleeve component capable of being slidingly engaged and disengaged to permit placement and removal), a roller-lock coupling (rollers are positioned around the inner diameter of the socket to grip the plug), a pin-lock coupling (uses pins arranged in a truncated-cone formation to grip and hold the plug in the socket), or a cam and groove or “camlock” style quick connect/disconnect.

In addition, the fishing lure or terminal tackle of first embodiment may be further characterized in one or more of the following manners: wherein one or both of the socket component and plug component comprise a releasable locking mechanism adapted to releasably lock the plug component in place once inserted in the socket component.

In a second exemplary embodiment, the present invention provides a fishing lure or terminal tackle system providing a uniform quick-release capability, the system comprising: a plurality of fishing lures or terminal tackle components each having a hook and a common quick-attach socket component; and a separable quick-attach plug component having a fishing line connector for attaching a fishing line to the lure; and a locking component whereby the plug component may be inserted into a socket component of any one of the plurality of fishing lures or terminal tackle components in a secure fashion for use in fishing and may be quickly removed from the socket of any one of the plurality of fishing lures or terminal tackle components and attached to a common socket of any other one of the plurality of fishing lures or terminal tackle components for switching lures without removing or disturbing the fishing line attached to the plug component.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention but are intended to be exemplary and for reference.

FIGS. 1 (A)-(C) provide a series of views of a first embodiment of a fishing lure adapted with the quick-attach mechanism according to the present invention.

FIGS. 2 (A)-(C) provide a series of views of a second embodiment of a fishing lure adapted with the quick-attach mechanism according to the present invention.

FIGS. 3 (A)-(B) provide views of a third embodiment of a fishing lure adapted with the quick-attach mechanism according to the present invention.

FIG. 4 provides a cross-section view of one embodiment of a quick-attach mechanism for use with a fishing lure according to the present invention.

### DETAILED DESCRIPTION

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes or in any number of markets. Accordingly, the claims set forth below should be construed in view of the full breadth and spirit of the present invention as disclosed herein.

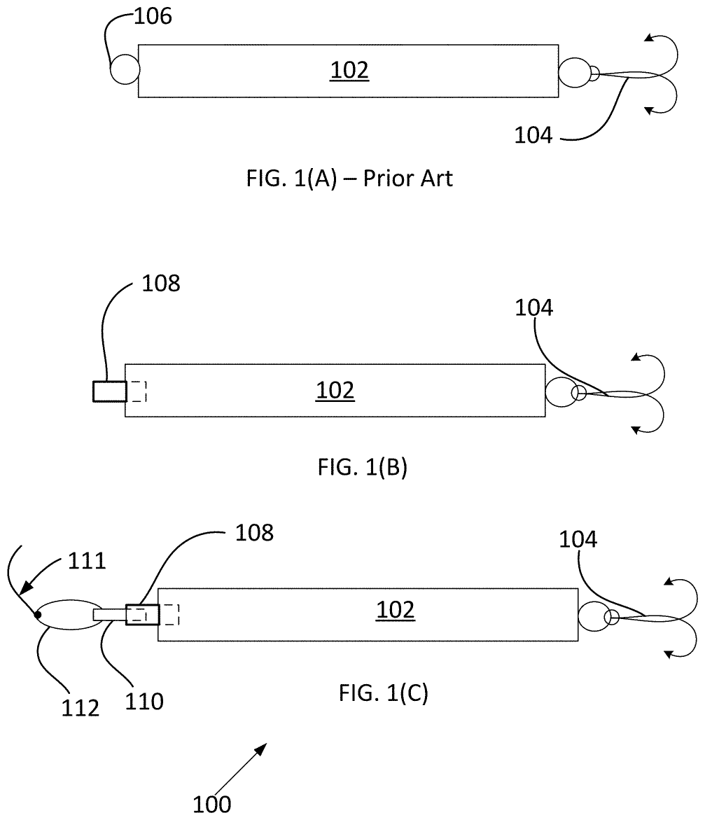

FIGS. 1 (A)-(C) provide a series of views of a first embodiment 100 of a fishing lure adapted with the quick-attach mechanism according to the present invention. Although the invention is described in connection with a lure it is understood that any terminal tackle may incorporate the inventive quick connect/disconnect feature for beneficial use. As shown in FIG. 1(A), a fishing lure 100 is shown in a prior art configuration having a body 102 with a hook component 104 at a first end and an attachment mechanism 106, shown as an eye hook or eye bolt, at a second end. As shown in FIG. 1(B), the fishing lure 100 has been modified to remove the simple eye bolt 106 and in its place a socket 108 is provided and is adapted to receive a plug to provide a quick-attach mechanism. As shown in FIG. 1(C), the fishing lure 100 is shown with a plug 110 received into the socket 108 with the quick-attach mechanism in a secured configuration. A fishing line 111 is shown connected to the plug component 110 by a fishing line connector 112.

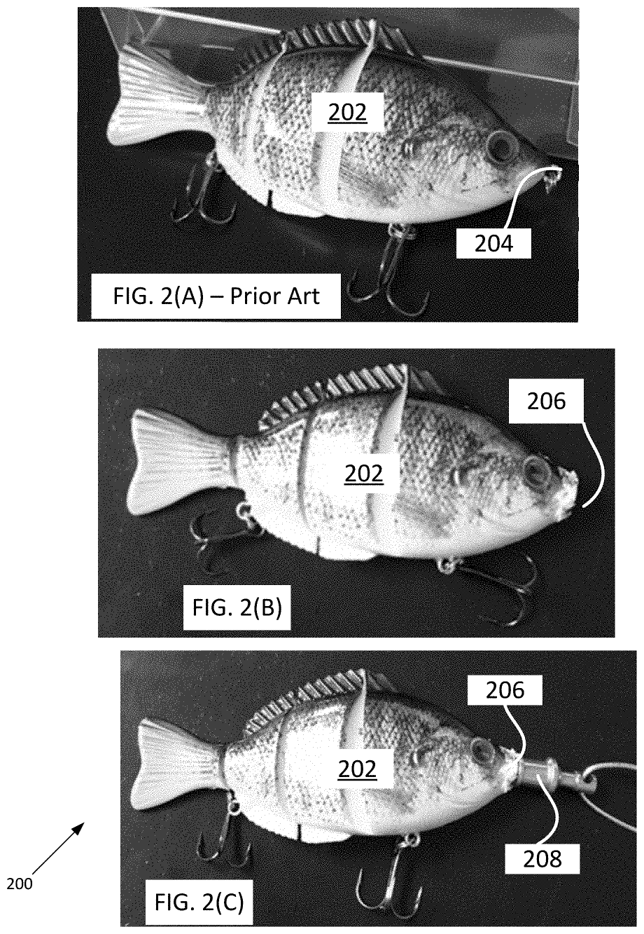

FIGS. 2 (A)-(C) provide a series of views of a second embodiment of a fishing lure 200 adapted with a quick-attach mechanism according to the present invention. As shown in FIG. 2(A), a fishing lure 200 is shown in a prior art configuration having a body 202 with a hook component and an attachment mechanism 204, shown as a closed ring, at a second end. As shown in FIG. 2(B), the fishing lure 200 has been modified to remove the simple ring 204 and in its place a socket 206 is provided and is adapted to receive a plug to provide a quick-attach mechanism. As shown in FIG. 2(C), the fishing lure 200 is shown with a plug 208 received into the socket 206 with the quick-attach mechanism in a secured configuration.

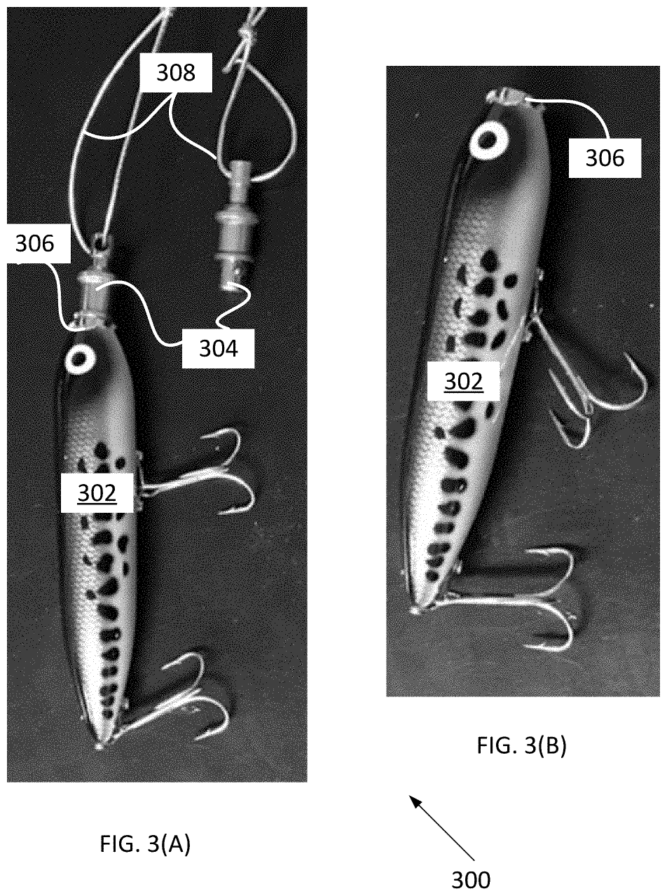

FIGS. 3 (A)-(B) provide views of a third embodiment of a fishing lure 300 adapted with a quick-attach mechanism according to the present invention. As shown in FIG. 3(A), a fishing lure 300 is shown having a socket 306 as provided and adapted to receive a plug 304 to provide a quick-attach mechanism. The plug 304 includes a fishing line connection mechanism, here an enclosed passage or through hole, through which fishing line 308 is passed and secured, such as by way of a knot. A second plug 304 is shown unattached to the fishing lure 300 for illustration purposes. Also, FIG. 3(B) illustrates the fishing lure 300 without the plug 304 inserted and secured in place. As shown in this example, plug 304 is of the ball-lock type.

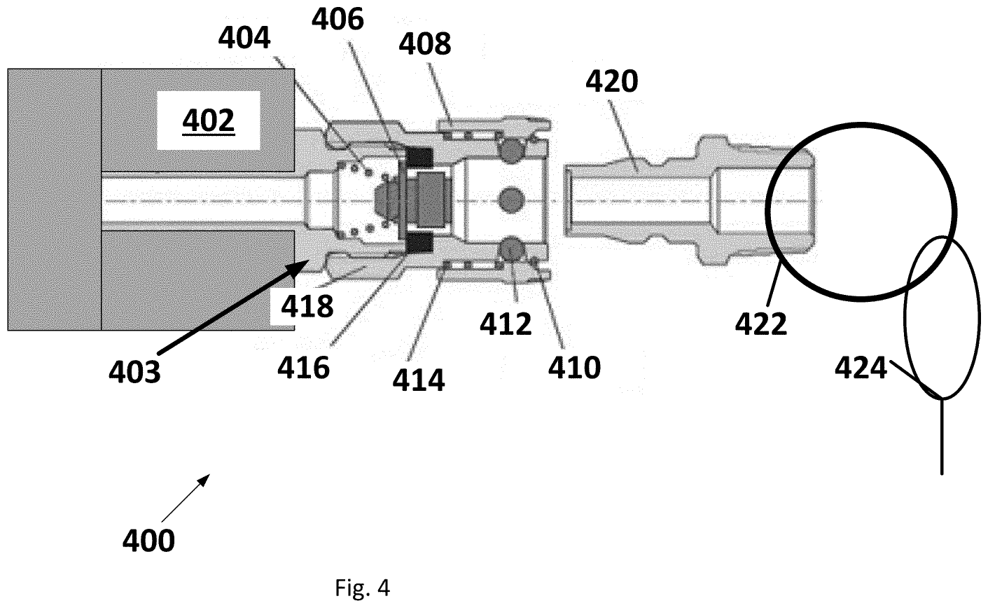

FIG. 4 provides a cross-section view of one embodiment of a quick-attach ball-lock type mechanism for use with a fishing lure according to the present invention. As shown, fishing lure 400 includes a partial view of a lure body 402 with a socket component 403. The socket component 403 is shown as an assembly comprising a first spring 404, a spring base support 406, a sliding retention sleeve 408, a lock ring 410, a ball bearing or ball 412, a second spring 414, an optional O-ring or seal 416, and a two-piece socket body 418. The socket 403 is configured for sliding mating engagement with plug component 420. Plug 420 includes a fishing line securing means 422, shown here as a simple ring, for securing a fishing line 424 to the plug. To secure plug 420 to the fishing lure body 402, socket 403 receives plug 420 by sliding sleeve 408 in a direction to free outward movement of ball or ball-bearing 412. Once the plug 420 is inserted into the socket 403, sleeve 408 is returned to a retention position to secure plug 420 into socket 403 and to connect the fishing line 424 to the fishing lure 400. In a reverse operation, the fishing line and plug are easily removed or disconnected from the fishing lure 400 and another fishing lure with similar socket component may be quickly connected or attached to the plug 420 and fishing line 424.

By way of example as to various forms of quick-attach mechanisms suitable for the above-stated purpose, the fishing lures of FIGS. 1-3 may be in the form of any of a number of suitable quick-acting (or quick connect/disconnect) couplings. For purposes of explaining the operation of such quick-acting couplings, we offer the following acceptable types which all have essentially three common elements: a plug, a socket, and a locking mechanism. The plug is the “male” half and the socket is the “female” half. When connected, the parts connected by way of the plug and socket form a joint or junction and are locked and resist tensile forces that tend to pull the joint apart. Typically, the parts may be easily disconnected by hand by simply disengaging a locking mechanism and separating the parts respectively connected to the plug and socket. For example, the invention may be in the form of a ball-lock coupling (for example having a ring-shaped ball bearing component retained in a sleeve component capable of being slidingly engaged and disengaged to permit placement and removal), a roller-lock coupling (rollers are positioned around the inner diameter of the socket to grip the plug), a pin-lock coupling (uses pins arranged in a truncated-cone formation to grip and hold the plug in the socket), or a cam and groove or “camlock” style quick connect/disconnect.

In a first embodiment the present invention provides a fishing lure or terminal tackle comprising a body, a hook, a quick-attach socket component, and a separable quick-attach plug component having a fishing line connector, whereby the plug component may be inserted into the socket component, one or both of the socket component and plug component comprising a releasable locking mechanism adapted to releasably lock the plug component in place once inserted in the socket component.

In another embodiment the invention provides a fishing lure or terminal tackle system comprising: a plurality of fishing lures or terminal tackle components each having a hook and a common quick-attach socket component; and a separable quick-attach plug component having a fishing line connector, whereby the plug component may be inserted into a socket component of any one of the plurality of fishing lures or terminal tackle components, one or both of the socket component and plug component comprising a releasable locking mechanism adapted to releasably lock the plug component in place once inserted in the socket component.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes or in any number of markets. Accordingly, the claims set forth below should be construed in view of the full breadth and spirit of the present invention as disclosed herein.

What is claimed is:

1. A fishing lure or terminal tackle comprising:
a body having a first end and a second end;
a hook fixably secured to the body at the first end;
a quick-attach socket component affixed to the body at the second end and having a female receiving portion adapted to removably receive and attach a male plug component; and
a separable quick-attach plug component configured to be mating received into the socket and having a fishing line connector for attaching a fishing line to the lure;
a releasable locking component connecting the plug component with the socket component, whereby the plug component may be inserted into the socket component in a secure fashion for use in fishing and may be quickly removed from the socket for switching lures without removing or disturbing the fishing line attached to the plug component.

2. The fishing lure or terminal tackle of claim 1, wherein one or both of the socket component and plug component comprise a releasable locking mechanism adapted to releasably lock the plug component in place once inserted in the socket component.

3. The fishing lure or terminal tackle of claim 1, wherein the releasable locking component is one from a group consisting of a ball-lock coupling, a roller-lock coupling, a pin-lock coupling, and a cam and groove or “camlock” style quick connect/disconnect.

4. The fishing lure or terminal tackle of claim 3, wherein the ball-lock coupling includes a ring-shaped ball bearing component retained in a sleeve component capable of being slidingly engaged and disengaged to permit placement and removal.

5. The fishing lure or terminal tackle of claim 3, wherein the roller-lock coupling includes rollers positioned around the inner diameter of the socket to grip the plug.

6. The fishing lure or terminal tackle of claim 3, wherein the pin-lock coupling uses pins arranged in a truncated-cone formation to grip and hold the plug in the socket.

7. A fishing lure or terminal tackle system providing a uniform quick-release capability, the system comprising:
a plurality of fishing lures or terminal tackle components each having a hook and a common quick-attach socket component; and
a separable quick-attach plug component having a fishing line connector for attaching a fishing line to the lure;
a releasable locking component connecting the plug component with the socket component, whereby the plug component may be inserted into a socket component of any one of the plurality of fishing lures or terminal tackle components in a secure fashion for use in fishing and may be quickly removed from the socket of any one of the plurality of fishing lures or terminal tackle components and attached to a common socket of any other one of the plurality of fishing lures or terminal tackle components for switching lures without removing or disturbing the fishing line attached to the plug component.

8. The system of claim 8, wherein one or both of the socket component and plug component comprise a releasable locking mechanism adapted to releasably lock the plug component in place once inserted in the socket component.

9. The system of claim 8, wherein the locking component is one from a group consisting of a ball-lock coupling, a roller-lock coupling, a pin-lock coupling, and a cam and groove or “camlock” style quick connect/disconnect.

10. The system of claim 8, wherein the ball-lock coupling includes a ring-shaped ball bearing component retained in a sleeve component capable of being slidingly engaged and disengaged to permit placement and removal.

11. The system of claim 8, wherein the roller-lock coupling includes rollers positioned around the inner diameter of the socket to grip the plug.

12. The system of claim 8, wherein the pin-lock coupling uses pins arranged in a truncated-cone formation to grip and hold the plug in the socket.
